(19) United States
(12) Patent Application Publication
(10) Pub. No.: US 2011/0113913 A1
(43) Pub. Date: May 19, 2011

(54) Gear Shifting Mechanism for the Vehicle Automatic Transmission

(75) Inventors: Yong Zheng, Wuhu (CN); Xinghui Lian, Wuhu (CN)

(73) Assignee: CHERY AUTOMOBILE CO., LTD.

(21) Appl. No.: 13/002,960

(22) PCT Filed: Jul. 7, 2009
(86) PCT No.: PCT/CN09/72658

§ 371 Date: Jan. 6, 2011

(30) Foreign Application Priority Data
Jul. 8, 2008 (CN) 200810133071.3

(51) Int. Cl. F16H 59/02

(52) U.S. Cl. 74/473.12; 74/473.1

(57) ABSTRACT

A gear shifting mechanism for vehicle automatic transmission, including a housing, a spline shaft installed in the housing, an axial position sensor and a radial rotary position sensor installed on the spline shaft, a shift finger connected with the spline shaft through a spline, a gear selecting device and a gear shifting device respectively selected and shifted a gear through the shift finger. The gear selecting device utilizes a gear selecting proportional electromagnet for moving the shift finger, and controls the automatic gear shift by adjusting the current. The gear selecting device utilizes restoring springs, and the restoring springs are multiple levels disposed. In different positions, different springs can produce different spring force, a corresponding relationship is thus established between the force and the position, and the amount of the gear selecting positions is increasing with the amount of the springs increased, thus the automatic gear shift can be achieved in a transmission having more than six gears. Featured by compact structure and easy installation and TCU control, the present invention can control automatic gear shifting by adjusting the current.

### FIELD OF THE INVENTION

The present invention relates to a gear shifting mechanism for the vehicle automatic transmission, and in particular to a gear shifting actuating mechanism for automatic mechanical transmission (AMT), which belongs to the technical field of vehicle transmission.

### DESCRIPTION OF THE PRIOR ART

At the present, all the available automatic mechanical transmission for vehicles adopt motor control or hydraulic control. The motor control is poor in reliability, and its control mechanism involves major modification to the mechanical transmission and needs to integrate such elements as the gear selecting/shifting shaft or the gear selecting/shifting part into the gear shifting control mechanism. The hydraulic control has complicated structure and needs many control elements. The gear shifting mode adopted for hydraulic control is generally connection mode, which is unable to guarantee the connection strength and always leads to serious abrasion.

### SUMMARY OF THE INVENTION

In the view of the deficiencies of the prior art, the technical object of the present invention is to provide a gear shifting mechanism for automatic mechanical transmission, which utilizes the restoring springs, and which utilizes a gear selecting proportional electromagnet for moving the shift finger so as to achieve the control of gear shifting. Featured by compact structure, easy installation and simple TCU control (transmission gear box control unit), the present invention is capable of controlling the automatic gear shifting by adjusting the current.

The technical object of the present invention is achieved by adopting the following technical solution:

A gear shifting mechanism for vehicle automatic transmission, including a housing, a spline shaft installed in the housing, an axial position sensor and a radial rotary position sensor installed on the spline shaft, a shift finger connected with the spline shaft through a spline, a gear selecting device and a gear shifting device respectively selecting and shifting a gear through the shift finger. The axial position sensor monitors the gear selecting position in real time, and the radial position sensor monitors the gear shifting position in real time.

More specifically, the gear selecting device comprises a gear selecting proportional electromagnet, a spring mechanism, a first segment gear, a stopper, a second segment gear and a shift lever. As soon as the gear selecting proportional electromagnet is powered on, its push rod moves towards the outside of the gear selecting proportional electromagnet pushing the stopper connected with the first segment gear and thus driving the first segment gear to rotate around its own rotation axes. The first segment gear drives the second segment gear engaged with it to rotate; in the process of rotation, the second segment gear drives the shift lever to rotate that is fixed on the same shaft; and the rotation of the shift lever may enable the shift finger to make axial movement along the spline shaft so as to achieve the gear selecting action. The gear shifting device comprises a forward gear shifting proportional electromagnet, a backward gear shifting proportional electromagnet and a gear shifting block that is connected with the spline shaft through a pin. As soon as the forward gear shifting proportional electromagnet is powered on, its push rod moves outward relative toward to itself and thus pushes the gear shifting block; meanwhile, the backward gear shifting proportional electromagnet being opposite to the forward gear shifting proportional electromagnet is power-off, and the clockwise rotation of the gear shifting block drives the spline shaft to rotate so as to achieve gear shifting. When the backward gear shifting proportional electromagnet is powered on and the forward gear shifting proportional electromagnet is power-off, the counterclockwise gear shifting is achieved.

The restoration of the shift finger is controlled by a three-level spring mechanism, wherein the stiffness of the first spring is higher than that of the second spring, and the stiffness of the second spring is higher than that of the third spring. The force, Fₑₗ, of the gear shifting proportion electromagnet is transmitted to the shift finger through the sector gear and becomes F_{ed} after being transmitted; if the force F_{ed} is higher than the spring force, F12max, corresponding to the maximum compression amount of the third spring, and is less than the pre-installation spring force F10min of the second spring, the third spring will be compressed, and the shift finger will be positioned at the end face of the second spring base, so that the shift finger is accurately positioned for gear selection. Therefore, it is feasible to control the force Fₑₗ of the gear shifting proportional electromagnet by controlling the current of gear shifting proportional electromagnet, so as to achieve the positioning of the multiple gear selection positions.

The automatic control of even more gear selection positions of the transmission may be achieved by increasing the level numbers of the spring.

The gear shifting mechanism of the present invention is applicable to electrically controlled automatic mechanical transmission.

The present invention utilizes restoring springs as the return means, and the proportional electromagnet as the driving means for the shift finger. The restoring springs are multiple levels disposed in progressive levels, so that at different positions, different springs produces different spring force, and a corresponding relationship is thus established between the force and the position. The amount of the gear selecting positions may be increased by providing more levels of the spring, and the automatic gear shift in a transmission having more than six gears can be thus achieved. Featured by compact structure, easily-assembled and simple TCU control, the present invention is capable of controlling the automatic gear shifting by adjusting the current.

### BRIEF DESCRIPTION OF THE DRAWINGS

FIG. 1 is the schematic structural diagram of the gear shifting mechanism of the present invention;

FIG. 2 is the schematic structural diagram of the gear selecting action of the present invention;

FIG. 3 is the schematic structural diagram of the gear shifting action of the present invention.

Description of the reference numerals in the attached drawings:

1—Housing; 2—Gear selecting proportional electromagnet; 3—Radial rotary position sensor; 4—Axial position sensor; 5—Backward gear shifting proportional electromagnet; 6—Forward gear shifting proportional electromagnet; 7—Shift lever; 8—the first spring; 9—First spring base; 10—Second spring; 11—Second spring base; 12—Third spring; 13—Shift finger; 14—Pin; 15—Gear shifting block; 16—First segment gear; 17—Second segment gear; 18—Spline shaft; 19—Stopper.

### DETAILED DESCRIPTION OF THE PREFERRED EMBODIMENTS

The technical solution of the present invention is elaborated below with reference to the attached drawings and the specific embodiments.

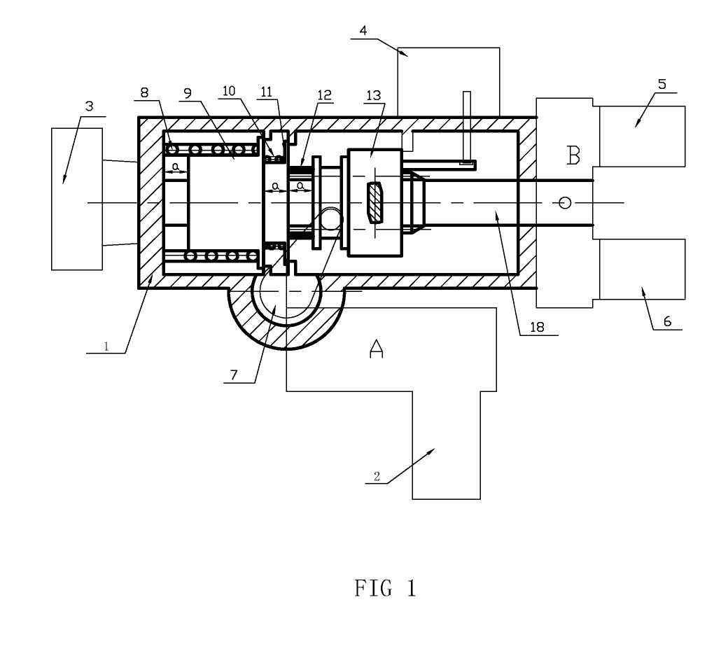

FIG. 1 is the schematic structural diagram of the gear shifting mechanism of the present invention; As shown in FIG. 1, the shift finger 13 is connected with the spline shaft 18 through a spline, and it can move axially along the spline shaft 18 (gear selecting action). The spline shaft 18 is installed on the housing 1; it can rotate around its own axis (gear shifting action), but can not move in axial direction. A axial position sensor 4 and a radial rotary position sensor 3 are installed on the spline shaft 18 for monitoring the gear selecting position and the gear shifting position respectively in real time. The shift finger 13 has direct interaction with the gear shifting sliding block in the transmission.

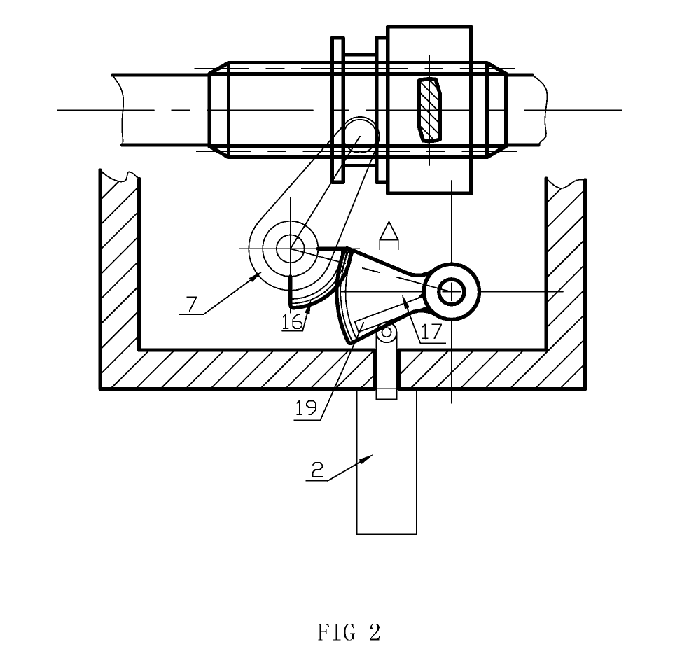

FIG. 2 is the schematic structural diagram of the gear selecting action of the present invention; When the gear selecting proportional electromagnet 2 is powered on, its push rod moves towards the outside of the proportional electromagnet 2, and the force applied by it increases with the increase in current. The restoration of the shift finger 13 is controlled by a progressive spring mechanism of three spring levels. The three spring levels have different spring stiffness such as to obtain different gear selecting positions under different forces, and the spring bases 9 and 11 are used to position the springs and the selected gears. The amount of compression and the accurate gear selecting positions of the first spring 8 and the third spring 12 are determined by the first spring base 9 and the left end face of the shift finger 13. The restoring position of the first spring 8 is jointly determined by the flange of the first spring base 9 and the boss on the housing 1; the restoring position of the second spring 10 is jointly determined by the flange of the second spring base 11 and the boss on the housing 1; the restoring position of the third spring 12 is jointly determined by the right end face of the shift finger 13 and the boss on the housing 1.

The stiffness of the first spring 8 is higher than that of the second spring 10, and the stiffness of the second spring 10 is higher than that of the third spring 12. Furthermore, when the third spring 12 reaches its maximum amount of compression, its spring force F12max and the pre-installation spring force F10min of the second spring 10 has the following relation:

F12max<F10min;

When the second spring 10 reaches the maximum amount of compression, its spring force F10max and the pre-installation spring force F8min of the first spring 8 has the following relation:

F10max<F8min;

In like manner, in case a transmission having 8 or more gears is in need, the automatic control of such a transmission may be realized by providing more levels of spring.

As shown in FIG. 2 in combination with FIG. 1, when the push rod of the proportional electromagnet 2 moves outwards, the push rod pushes the stopper 19 that is connected with the first sector gear 17. The first sector gear 17 rotates around its own rotation axes and drives the second sector gear 16 engaged with it to rerate; in the process of rotation, the second sector gear 16 drives the shift lever 7 fixed on the same shaft to rerate. The rotation of the shift lever 7 may enable the shift finger 13 to make axial movement along the spline shaft 18, so as to achieve the gear selecting action. the force, Fₑₗ, of the gear shifting proportion electromagnet 2 is transmitted to the shift finger 13 through the sector gear and becomes F_{ed} after being transmitted; if the force F_{ed} is higher than the spring force, F12max, corresponding to the maximum compression amount of the third spring 12, and is less than the pre-installation spring force F10min of the second spring 10, the third spring 12 will be compressed, and the shift finger will be positioned at the end face of the second spring base 11, so that the shift finger is accurately positioned for gear selection. Therefore, it is feasible to control the force, Fₑₗ, of the proportional electromagnet 2 by controlling the current of the proportional electromagnet 2, so as to achieve the positioning of multiple gear selection positions. In addition, for different transmissions, the transmission ratio between the second sector gear 16 and the first sector gear 17 may be adjusted so as to achieve the universal applicability of the same parts for different multi-gear transmissions, that is to say, the proportional electromagnet 2 thus has relatively strong universal applicability.

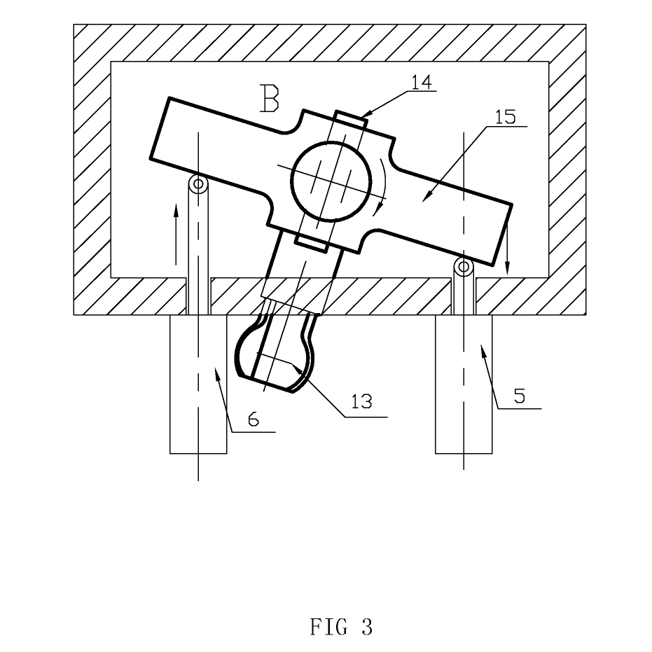

FIG. 3 is the schematic structural diagram of the gear shifting action of the present invention. As shown in FIG. 3, as soon as the forward gear shifting proportional electromagnet 6 is powered on, its push rod moves towards to its outside and thus pushes the gear shifting block 15; meanwhile, the backward gear shifting proportional electromagnet 5 being opposite to the forward gear shifting proportional electromagnet 6 is power-off. The gear shifting block 15 can make clockwise rotation; and because it is connected with the spline shaft 18 through the pin 14, the gear shifting block 15 in clockwise rotation drives the spline shaft 18 to rotate. Subsequently the spline shaft 18 drives the shift finger 13 to rotate around its rotation center and thus activates the sliding track in the transmission to achieve gear shifting. If the backward gear shifting proportional electromagnet 5 is powered on, the counterclockwise gear shifting will be achieved.

The positioning of the gear selecting positions are realized by controlling the current of the gear selecting proportional electromagnet 2, and the gear selecting position is fed back to TCU via the axial position sensor 4. The gear shifting of odd number gears and even number gears may be realized by controlling the forward gear shifting proportional electromagnet 6 and the backward gear shifting proportional electromagnet 5 respectively, and the gear shifting position is fed back to TCU through the radial rotary position sensor 3 so that the automatic gear positioning may be realized through the control of TCU.

In the above embodiment, the rotation driving power of the gear shifting shaft is provided by the proportional electromagnet. In fact, such rotation driving power may also be provided by a hydraulic cylinder or a motor.

Finally, it must be mentioned that: The above description and embodiments are merely used to describe rather than limit the present invention. Although the detailed description of the present invention is provided with reference to preferred embodiments, those skilled in the art should understand that all the modifications or equitable substitutions to the present invention without deviation from the spirit and conception of present invention shall be covered by the claims of present invention.

1. A gear shifting mechanism for vehicle automatic transmission, characterized in the following: including a housing (1), a spline shaft (18) installed in the housing, an axial position sensor (4) and a radial rotary position sensor (3) installed on the spline shaft (18), a shift finger (13) connected with the spline shaft through a spline, a gear selecting device and a gear shifting device, which perform gear selection and gear shift respectively through the shift finger (13).

2. The gear shifting mechanism for vehicle automatic transmission of claim 1, characterized in the following: the gear selecting device comprises a gear selecting proportional electromagnet (2), a spring mechanism, a first sector gear (17), a stopper (19), a second sector gear (16) and a shift lever (7); wherein as soon as the gear selecting proportional electromagnet (2) is powered on, its push rod moves toward the outside of the gear selecting proportional electromagnet (2) pushing the stopper (19) connected with the first sector gear (17) and thus driving the first sector gear (17) to rotate around its own rotation shaft; the first sector gear (17) drives the second sector gear (16) engaged with it to rotate; in the process of rotation, the second sector gear (16) drives the shift lever (7) fixed on the same shaft to rotate; the rotation of the shift lever (7) enables the shift finger (13) to make axial movement along the spline shaft (18) so as to achieve the gear selecting action.

3. The gear shifting mechanism for vehicle automatic transmission of claim 1, characterized in the following: the gear shifting device comprises a forward gear shifting proportional electromagnet (6), a backward gear shifting proportional electromagnet (5) and a gear shifting block (15) that is connected with the spline shaft (18) through the pin (14); as soon as the forward gear shifting proportional electromagnet (6) is powered on, its push rod moves towards its outside and thus pushes the gear shifting block (15); meanwhile, the backward gear shifting proportional electromagnet (5) being opposite to the forward gear shifting proportional electromagnet is powered off, and the gear shifting block (15) makes clockwise rotation and thus drives the spline shaft (18) to rotate so as to achieve gear shifting.

4. The gear shifting mechanism for vehicle automatic transmission of claim 3, characterized in the following: when the backward gear shifting proportional electromagnet (5) is powered on and the forward gear shifting proportional electromagnet (6) is powered off, the counterclockwise gear shifting is achieved.

5. The gear shifting mechanism for vehicle automatic transmission of claim 2, characterized in the following: the restoration of the shift finger (13) is controlled by a three-level spring mechanism; wherein the stiffness of the first spring (8) is higher than that of the second spring (10), and the stiffness of the second spring (10) is higher than that of the third spring (12); in addition, when third spring (12) reaches its maximum amount of compression, its spring force, F12max, and the pre-installation spring force, F10min, of the second spring (10) has the following relation:
F12max<F10min;
When the second spring (10) reaches the maximum amount of compression, its spring force, F10max, and the spring pre-installation spring force, F8min, of the first spring (8) has the following relation:
F10max<F8min.

6. The gear shifting mechanism for vehicle automatic transmission of claim 5, characterized in the following: the force, Fₑₗ, of the gear shifting proportion electromagnet (2) is transmitted to the shift finger (13) through the sector gear and becomes F_{ed} after being transmitted; if the force F_{ed} is higher than the spring force, F12max, corresponding to the maximum compression amount of the third spring (12), and is less than the pre-installation spring force F10min of the second spring (10), the third spring (12) will be compressed, and the shift finger will be positioned at the end face of the second spring base (11), so that the shift finger is accurately positioned for gear selection.

7. The gear shifting mechanism for vehicle automatic transmission of claim 6, characterized in that: the amount of compression and the accurate gear selecting positions of the first spring (8) and the third spring (12) are determined by the first spring base (9) and the left end faces of the shift finger (13).

8. The gear shifting mechanism for vehicle automatic transmission of claim 6, characterized in the following: the restoring position of the first spring (8) is jointly determined by the flange of the first spring base (9) and the boss on the housing (1); the restoring position of the second spring (10) is jointly determined by the flange of the second spring base (11) and the boss on the housing (1); the restoring position of the third spring (12) is jointly determined by the right end face of the shift finger (13) and the boss on the housing (1).

9. The gear shifting mechanism for vehicle automatic transmission of claim 2, characterized in the following: the force, Fₑₗ, of the gear shifting proportional electromagnet (2) may be controlled by controlling the current of the gear shifting proportional electromagnet (2) so as to achieve the positioning of multiple gear selection positions.

10. The gear shifting mechanism for vehicle automatic transmission of claim 1, characterized in the following: the axial position sensor (4) monitors the gear selecting position in real time and the radial position sensor (3) monitors the gear shifting position in real time.

11. The gear shifting mechanism for vehicle automatic transmission of claim 5, characterized in the following: the automatic control of even more gear positions of the transmission may be achieved by providing more levels of spring.

12. The gear shifting mechanism for vehicle automatic transmission of claim 1, characterized in the following: the gear shifting mechanism is applicable to electrically controlled automatic mechanical transmission.
